(19) United States
(12) Patent Application Publication
(10) Pub. No.: US 2005/0218800 A1
(43) Pub. Date: Oct. 6, 2005

(54) Organic electro-luminescence display device and fabricating method thereof

(76) Inventor: Il Ho Lee, Gyeongsangbuk-do (KR)

Correspondence Address: BIRCH STEWART KOLASCH & BIRCH, PO BOX 747, FALLS CHURCH, VA, 22040-0747, US

(21) Appl. No.: 11/093,283

(22) Filed: Mar. 30, 2005

(30) Foreign Application Priority Data
Apr. 1, 2004 (KR) P2004-22639

(51) Int. Cl. H05B 33/00

(52) U.S. Cl. 313/506; 313/504

(57) ABSTRACT

An organic electro-luminescence display device and a fabricating method thereof for minimizing a dimension of the device are disclosed. In the organic electro-luminescence display device, an organic electro-luminescence array has first and second electrodes crossing each other with having an organic light-emitting layer therebetween. A signal supplying pad supplies a driving signal to the organic electro-luminescence array. At least one layer of protective film is provided on the organic electro-luminescence array to expose a portion of any at least one of the first and second electrodes. A signal line has at least portion thereof provided on the protective film and is connected to the electrode and the signal supplying pad.

This application claims the benefit of Korean Patent Application No. P2004-22639 filed in Korea on Apr. 1, 2004, which is hereby incorporated by reference.

### BACKGROUND OF THE INVENTION

1. Field of the Invention

This invention relates to an electro-luminescence display (ELD), and more particularly to an organic electro-luminescence display device and a fabricating method thereof that are adaptive for minimizing a dimension of the device.

2. Description of the Related Art

Recently, there have been developed various flat panel display devices reduced in weight and bulk that is capable of eliminating disadvantages of a cathode ray tube (CRT). Such flat panel display devices include a liquid crystal display (LCD), a field emission display (FED), a plasma display panel (PDP) and an electro-luminescence (EL) display, etc. There have been actively processed studies for attempting to make a high display quality and a large-dimension screen of the flat panel display device.

In such flat panel display devices, the EL display device is a self-luminous device capable of light-emitting for himself. The EL display device excites a phosphorous material using carriers such as electrons and holes, thereby displaying a video image.

The EL display device is largely classified into an inorganic EL display device and an organic EL display device depending upon the used material. Since the organic EL display device is driven with a lower voltage (i.e., about 5 to 20V) than the inorganic EL display device requiring a high voltage of 100 to 200V, it permits a direct current low voltage driving. Also, since the organic EL display device has excellent characteristics such as a wide viewing angle, a fast response and a high contrast ratio, etc., it can be used for a pixel of a graphic display, or a pixel of a television image display or a surface light source. Further, the organic EL display device is a device suitable for a post generation flat panel display because it has a thin thickness, a light weight and an excellent color sense.

FIG. 1 is a schematic view showing a structure of a general organic EL display device, and FIG. 2 and FIG. 3 are detailed views of an organic EL array provided at the display area of the organic EL display device shown in FIG. 1.

Referring to FIG. 1 to FIG. 3, the conventional EL display device includes a display area P1 provided with an organic EL array, and a non-display area P2 provided with a pad portion 25 for applying driving signals to driving electrodes at the display area P1.

The display area P1 is provided with an anode electrode 4 formed on a substrate 2, and a cathode electrode 12 formed in a direction crossing the anode electrode 4.

A plurality of anode electrodes 4 are provided on the substrate 2 in such a manner to be spaced at a desired distance from each other. An insulting film 6 having an aperture for each EL cell area is formed on the substrate 2 provided with the anode electrode 4. On the insulating film 6, a barrier rib 8 for making a separation of an organic light-emitting layer 10 and a scan line 12 to be formed thereon is provided. The barrier rib 8 is formed in a direction crossing the anode electrode 4, and has an overhang structure in which the upper portion thereof has a larger width than the lower portion thereof. The organic light-emitting layer 10 made from an organic compound and the cathode electrode 12 are entirely deposited onto the insulating film 6 provided with the barrier rib 8. The organic light-emitting layer 10 is formed by depositing a hole carrier layer, a light-emitting layer and an electron carrier layer onto the insulating film 6.

The non-display area P2 is provided with a first line 54 extended from the anode electrode 4 at the display area P1, data pads for supplying data voltages, via the first line 52, to the anode electrode 4, a second line 52 connected to the cathode electrode 12, and scan pads for supplying scan voltages via the second line 52.

The data pad is connected to a tape carrier package (TCP) mounted with a first driving circuit for generating data voltages to thereby supply the data voltage to each anode voltage 4. The scan pad is provided at each side of the data pad. The scan pad is connected to a TCP mounted with a second driving circuit for generating scan voltages to thereby supply the scan voltage to each cathode electrode 12.

As shown in FIG. 4, in the conventional organic EL display device having the structure as mentioned above, if a voltage is applied between the anode electrode 4 and the cathode electrode 12, then electrons (or cathodes) generated from the cathode electrode 12 are moved, via an electron injection layer 10a and an electron carrier layer 10b, into a light-emitting layer 10c. On the other hand, holes (or anodes) generated from the anode electrode 4 are moved, via a hole injection layer 10d and a hole carrier layer 10e, into the light-emitting layer 10c. Thus, electrons and holes fed from the electron carrier layer 10b and the hole carrier layer 10e are collided with each other to be re-combined at the light-emitting layer 10c, thereby generating a light. This light is emitted into the exterior via the anode electrode 4, thereby displaying a picture.

Meanwhile, in such an organic EL display device, the first line 54 for electrically connecting the anode electrode 4 with the data pad is directly connected to the data pad, whereas the second line 52 connected with the cathode electrode 12 is distributed at the left and right sides of the display area P1, and goes around the display area P1 to be connected to the scan pad positioned at the non-display area P2. Therefore, there is raised a problem in that an area of the organic EL display device is enlarged by an area occupied by the second line 52.

### SUMMARY OF THE INVENTION

Accordingly, it is an object of the present invention to provide an organic electro-luminescence display device and a fabricating method thereof that are adaptive for minimizing a dimension of the device.

In order to achieve these and other objects of the invention, an organic electro-luminescence display device according to one aspect of the present invention includes an organic electro-luminescence array having first and second electrodes crossing each other with having an organic light-emitting layer therebetween; a signal supplying pad for supplying a driving signal to the organic electro-luminescence array; at least one layer of protective film provided on the organic electro-luminescence array to expose a portion of any at least one of the first and second electrodes; and a signal line having at least portion thereof provided on the protective film and connected to the electrode and the signal supplying pad.

In the organic electro-luminescence display device, the signal line is formed from the same material as any one of the first and second electrodes.

The organic electro-luminescence display device further includes a barrier rib provided in parallel to the signal line to separate the signal line.

Herein, the signal line and the barrier rib are formed in a bent shape.

Herein, the signal line and the barrier rib have an “L” shape.

In the organic electro-luminescence display device, the protective film exposes the end of any at least one of the first and second electrodes.

A method of fabricating an organic electro-luminescence display device according to another aspect of the present invention includes the steps of forming an organic electro-luminescence array including first and second electrodes crossing each other with having an organic light-emitting layer therebetween; forming a signal supplying pad for supplying a driving signal to the organic electro-luminescence array; forming at least one layer of protective film provided on the organic electro-luminescence array to expose a portion of any at least one of the first and second electrodes; and forming a signal line having at least portion thereof provided on the protective film and connected to the electrode and the signal supplying pad.

In the method, the signal line is formed from the same material as any one of the first and second electrodes.

The method further includes the step of forming a barrier rib provided in parallel to the signal line to electrically separate the signal line.

In the method, the first and second electrodes are formed by a photolithography and an etching process using a mask.

### BRIEF DESCRIPTION OF THE DRAWINGS

These and other objects of the invention will be apparent from the following detailed description of the embodiments of the present invention with reference to the accompanying drawings, in which:

FIG. 1 is a schematic view showing a structure of a conventional organic electro-luminescence display device;

FIG. 2 and FIG. 3 is detailed perspective view and section views of a display area of the organic electro-luminescence display device shown in FIG. 1;

FIG. 4 is a diagram for explaining a light-emitting principle of the conventional organic electro-luminescence display device;

FIG. 5 is a plan view showing a structure of an organic electro-luminescence display device according to an embodiment of the present invention;

FIG. 6 is a section view of the organic electro-luminescence display device taken along the II-II′ and III-III′ lines in FIG. 5; and

FIG. 7A to FIG. 7I are section views for sequentially explaining a method of fabricating the organic electro-luminescence display device shown in FIG. 6.

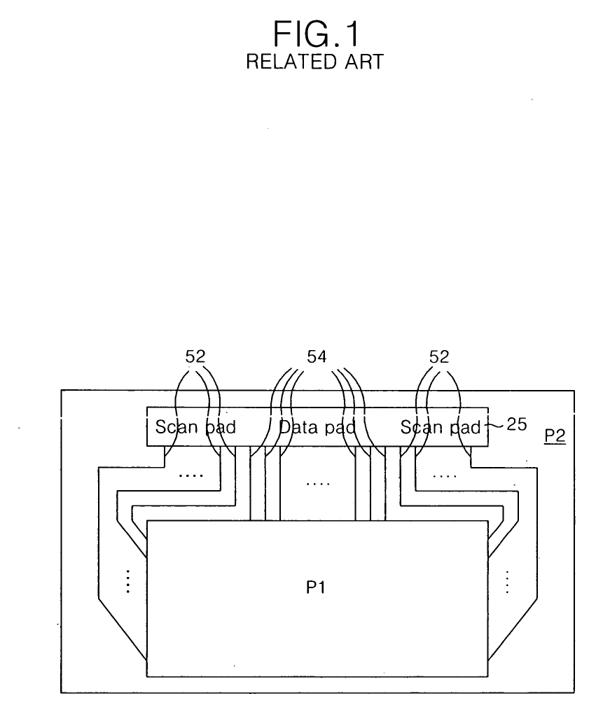

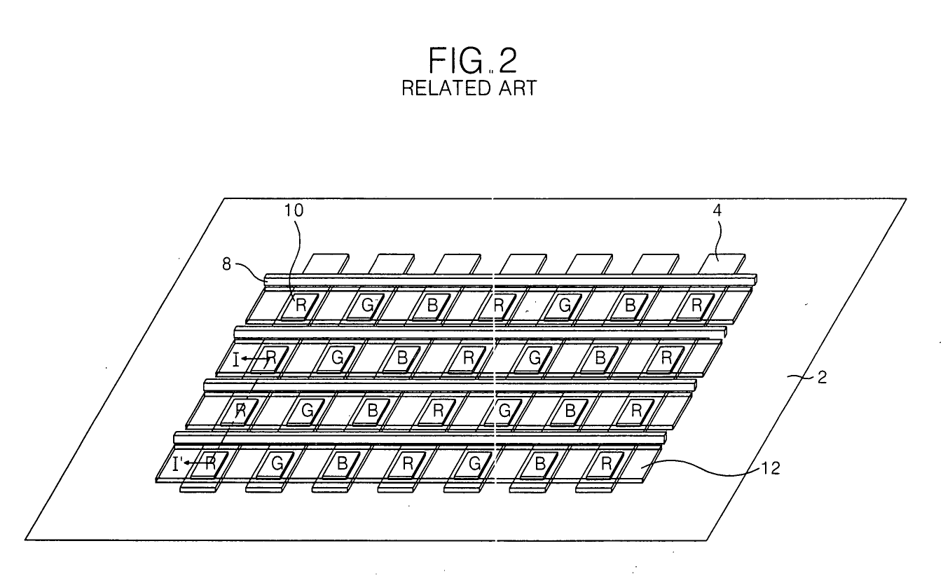

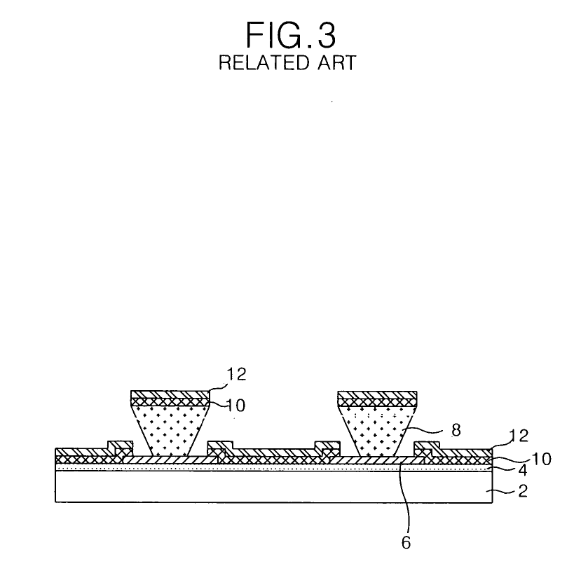

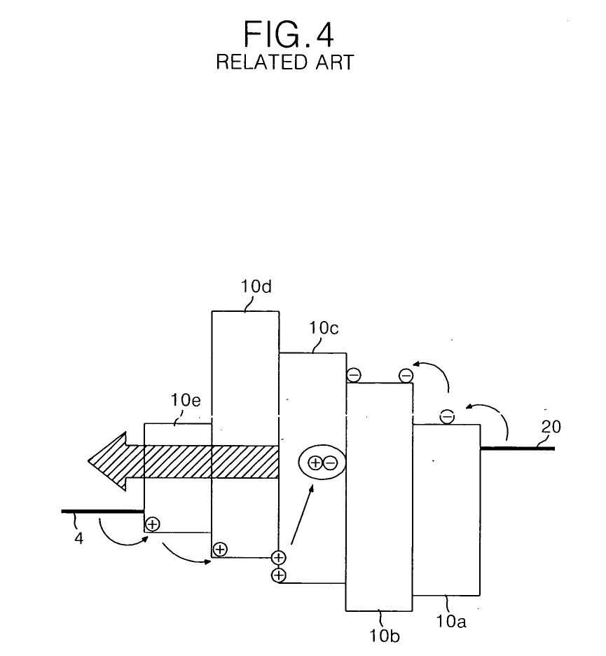

### DETAILED DESCRIPTION OF THE PREFERRED EMBODIMENT

Reference will now be made in detail to the preferred embodiments of the present invention, examples of which are illustrated in the accompanying drawings.

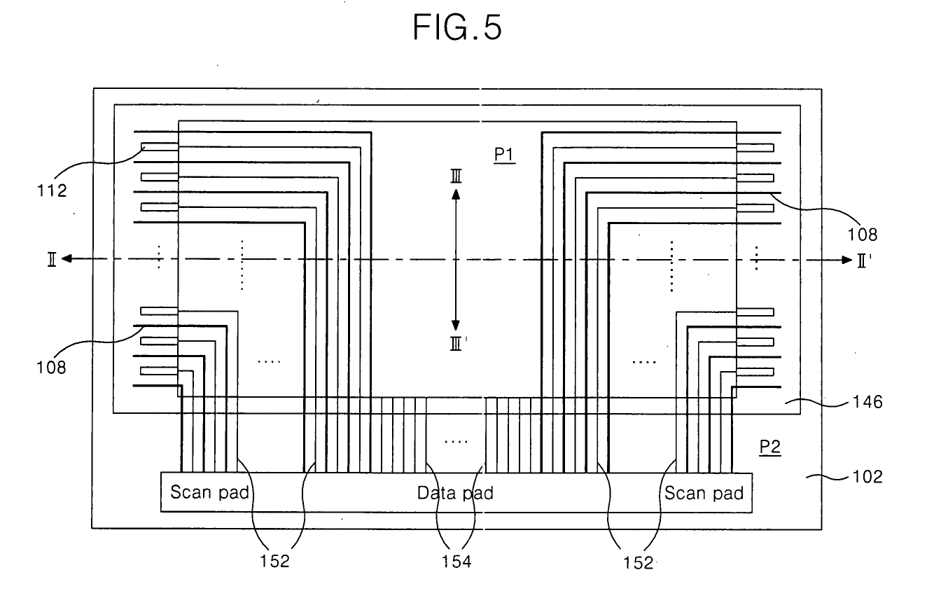

Hereinafter, the preferred embodiments of the present invention will be described in detail with reference to FIGS. 5 to 7I.

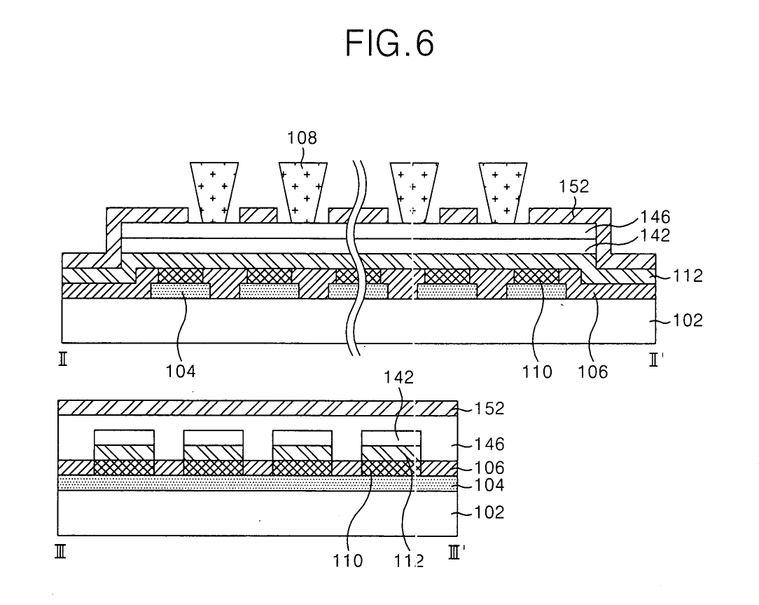

FIG. 5 is a plan view showing a structure of an organic electro-luminescence display device according to an embodiment of the present invention, and FIG. 6 is a section view of the organic electro-luminescence display device taken along the II-II′ and III-III′ lines in FIG. 5

Referring to FIG. 5 and FIG. 6, a display area P1 of the organic electro-luminescence (EL) display device includes an anode electrode 104 arranged in a stripe shape on a substrate 102, an insulating film 106 provided at an area other than a light-emitting area on the substrate 102, an organic light-emitting layer 110 provided on the light-emitting area defined by the insulating film 106, a cathode electrode 112 provided on the substrate 102 in such a manner to cross the anode electrode 104 in correspondence with the organic light-emitting layer 110, a first protective layer 142 provided in correspondence with the cathode electrode 112 for the purpose of protecting the cathode electrode 112, and a second protective layer 146 provided at the entire surface of the substrate 102 in such a manner to cover the insulating film 106 and the first protective film 142. The second conductive layer 146 exposes a portion of the cathode electrode 112, that is, the end of the cathode electrode 112 at the left and right outsides of the display area P1. The display area P1 of the organic EL display device includes a barrier rib 108 having an overhang structure and provided on the second protective layer 146 in a bent shape, for example, “L” shape, and a second line 152 separated by the barrier rib 108 and connected to the cathode electrode 112.

The non-display area P2 is provided with a first line 154 extended from the anode electrode 104 at the display area P1, data pads for supplying data voltages, via the first line 152, to the anode electrode 104, a second line 152 connected to the cathode electrode 112, and scan pads for supplying scan voltages via the second line 152.

The data pad is connected to a tape carrier package (TCP) mounted with a first driving circuit for generating data voltages to thereby supply the data voltage to each anode voltage 104. The scan pad is provided at each side of the data pad. The scan pad is connected to a TCP mounted with a second driving circuit for generating scan voltages to thereby supply the scan voltage to each cathode electrode 112.

In the organic EL display device having the structure as mentioned above, the second line 152 for electrically connecting the cathode electrode 112 with the scan pad is provided within the display area P1. Thus, the organic EL display device can reduce an area occupied by the second line 152 in comparison to the prior art, thereby minimizing a dimension of the device.

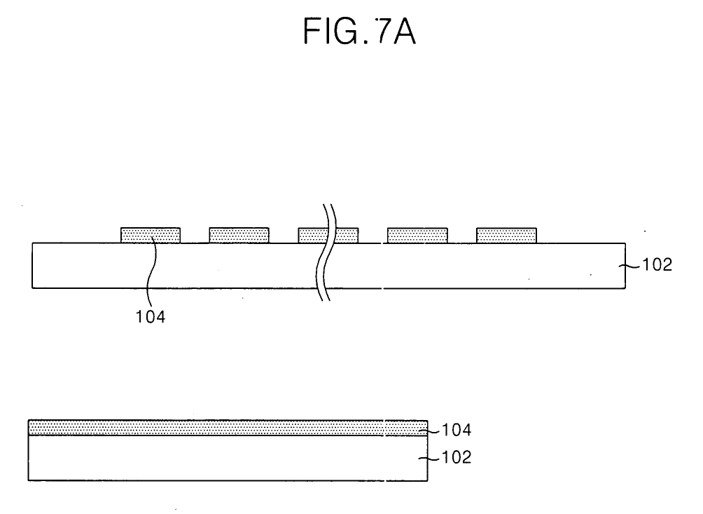

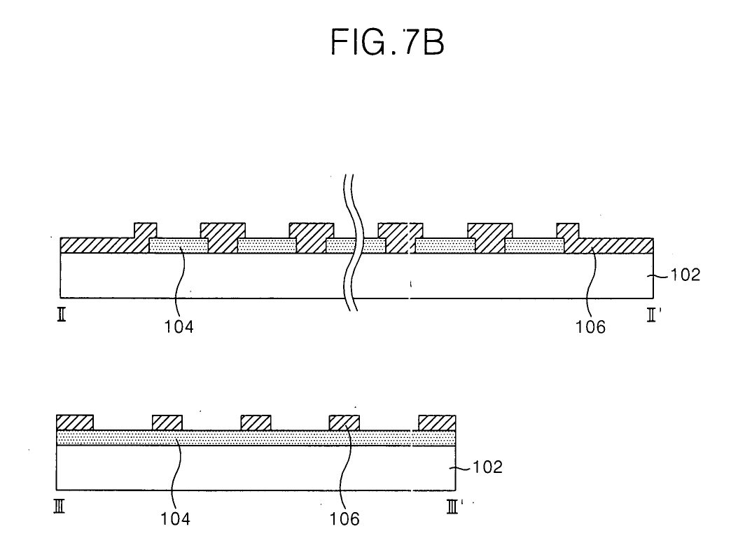

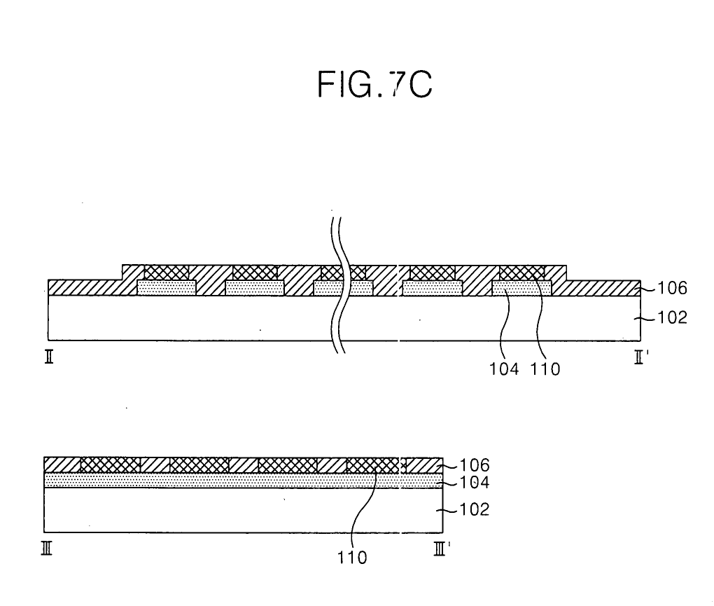

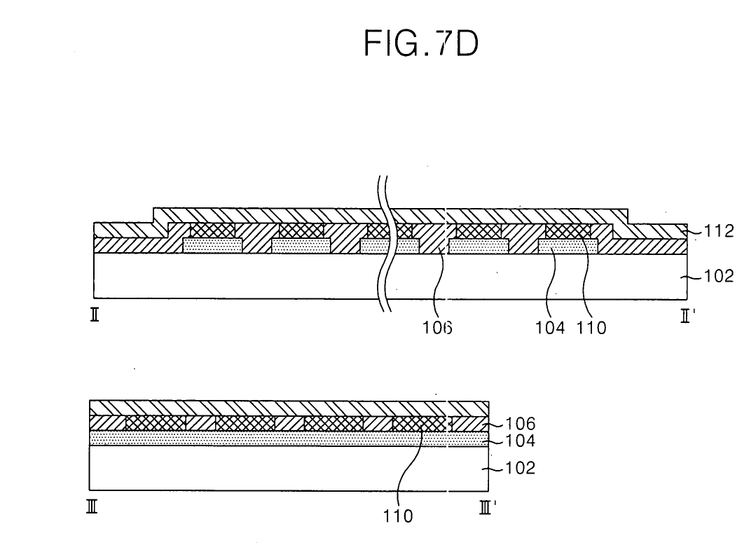

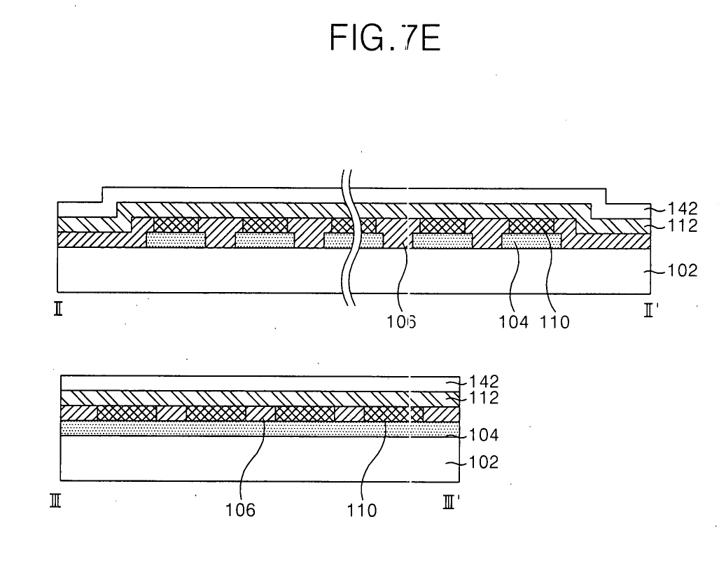

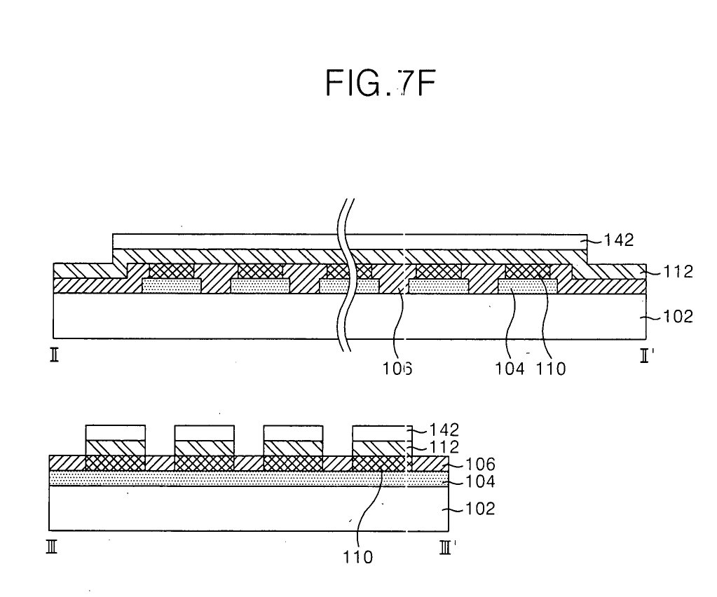

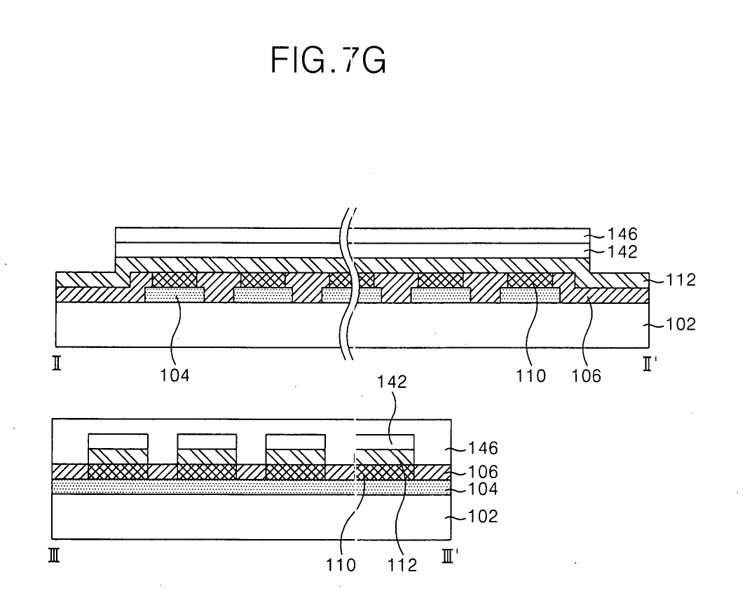

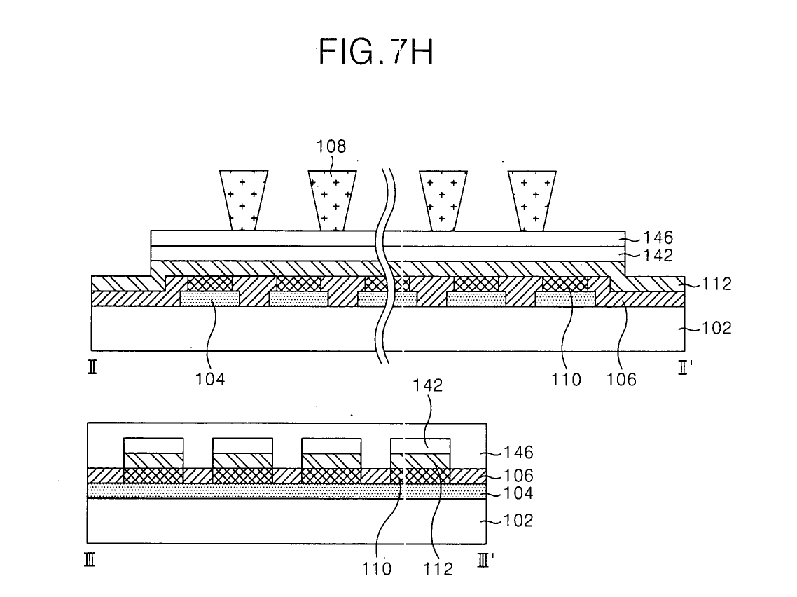

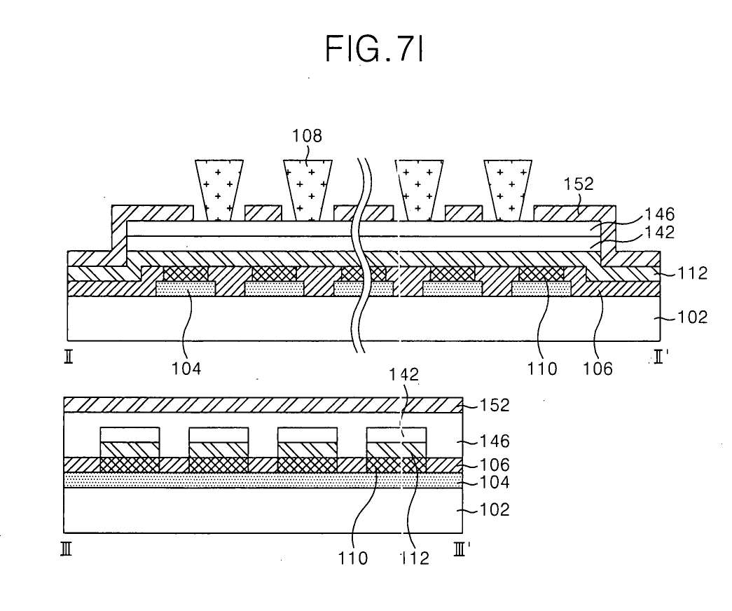

FIG. 7A to FIG. 7I are views for sequentially explaining a method of fabricating the organic EL display device shown in FIG. 6.

Firstly, the fabricating method illustrated in FIG. 7A to FIG. 7E employs the same fabricating method suggested in Korea Patent Application No. 10-2002-21874 pre-field by the applicant.

As shown in FIG. 7A, the anode electrode 104 is provided by depositing a metal transparent conductive material onto the substrate 102 made from a soda lime or a vulcanized glass and then patterning it by the photolithography and the etching process. Herein, indium-tin-oxide (ITO) or SnO₂ is used as the metal material.

As shown in FIG. 7B, the, insulating film 106 is formed in such a manner to expose a light-emitting area by coating a photosensitive insulating material onto the substrate 102 provided with the anode electrode 104 by the spin coating technique and then patterning it by the photolithography and the etching process.

As shown in FIG. 7C, the organic light-emitting layer 110 is formed at the hole-shaped light-emitting area defined by the patterned insulating film 106. In this case, the organic light-emitting layer 106 is provided by sequentially disposing a hole injection layer, a hole carrier layer, a light-emitting layer, an electron carrier layer and an electron injection layer, etc. on the anode electrode 104.

As shown in FIG. 7D, a cathode electrode material such as aluminum (Al), aluminum group alloy, chrome (Cr) or the like is deposited onto the entire surface of the substrate 102 provided with the organic light-emitting layer 110.

The first protective layer 142 made from an inorganic thin film layer by a low temperature process is formed on the substrate 102 provided with the cathode electrode material 112. Thereafter, the first protective layer 142 plays a role to prevent a damage of the surface of the cathode electrode 112 in the photolithography and the etching process for patterning the cathode electrode 112.

A sacrificing layer, for example, a photo resist such as AZ1512, AZ5214, AZ4533, AZ4562 or the like is formed on the first protective layer 142 and then the first protective layer 142 is patterned by the photolithography and the etching process. The first protective layer 142 is etched by a reactive ion etching (RIE) technique, which is a type of dry etching methods, in such a manner to exist only on the light-emitting area. At this time, the sacrificing layer is etched into a desired thickness by the RIE technique. The RIE technique is used for a fine pattern etching owing to excellent step coverage.

When the first protective layer 142 is etched, the cathode electrode material 112 is again patterned by utilizing the residual sacrificing layer as a mask, thereby providing the cathode electrode 112 crossing the anode electrode 104 and overlapping with the organic light-emitting layer 110. Herein, the cathode electrode 112 also is patterned by the RIE technique. Then, the sacrificing layer is removed by the stripping process.

Any one of an inorganic insulating material such as silicon nitride (SiNₓ) or silicon oxide (SiO₂) and an organic insulating material such as an acrylic resin is deposited onto the entire surface of the substrate 102 provided with the first protective layer 142 and the cathode electrode 112 by a plasma chemical vapor deposition (PECVD) technique and a physical vapor deposition (PVD) technique. Thereafter, the insulating material is patterned by the photolithography and the etching process using a mask to thereby provide the second protective layer 146 exposing a portion of the cathode electrode 112, that is, the end of the cathode electrode 112 as shown in FIG. 7F.

Particularly, when the first and second protective layers 142 and 146 are being deposited, the PECVD technique forms a film at a low process temperature of less than about 400° C., thereby preventing a damage of the organic light-emitting layer 110 and the cathode electrode 112.

A photosensitive organic material is deposited onto the substrate 142 provided with the second protective layer 146 and then is patterned by the photolithography and the etching process, thereby providing the barrier rib 108 having an overhang structure as shown in FIG. 7G. The barrier rib 108 is formed on the second protective layer 146 in a bent shape, for example, an “L” shape.

A metal material such as aluminum (Al) is entirely deposited onto the entire surface of the substrate 102 provided with the barrier rib 108 by a deposition technique such as an E-beam deposition. The metal material such as aluminum (Al) is separated by the barrier rib 108 to thereby provide the second line 152 connected to the cathode electrode 102.

In the organic EL display device according to the embodiment of the present invention and the fabricating method thereof, the second line 152 for electrically connecting the cathode electrode 112 with the scan pad is provided within the display area P1. Accordingly, an area occupied by the second line 152 in the prior art can be reduced to minimize a dimension of the device.

As described above, according to the present invention, the second line for electrically connecting the cathode electrode with the scan pad is provided within the display area. Accordingly, an area occupied by the second line the prior art can be reduced, so that it becomes possible to minimize a dimension of the device.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

1. An organic electro-luminescence display device, comprising:
an organic electro-luminescence array having first and second electrodes crossing each other with having an organic light-emitting layer therebetween;
a signal supplying pad for supplying a driving signal to the organic electro-luminescence array;
at least one layer of protective film provided on the organic electro-luminescence array to expose a portion of any at least one of the first and second electrodes; and
a signal line having at least portion thereof provided on the protective film and connected to the electrode and the signal supplying pad.

2. The organic electro-luminescence display device according to claim 1, wherein the signal line is formed from the same material as any one of the first and second electrodes.

3. The organic electro-luminescence display device according to claim 1, further comprising:
a barrier rib provided in parallel to the signal line to separate the signal line.

4. The organic electro-luminescence display device according to claim 3, wherein the signal line and the barrier rib are formed in a bent shape.

5. The organic electro-luminescence display device according to claim 3, wherein the signal line and the barrier rib have an “L” shape.

6. The organic electro-luminescence display device according to claim 1, wherein the protective film exposes the end of any at least one of the first and second electrodes.

7. A method of fabricating an organic electro-luminescence display device, comprising the steps of:
forming an organic electro-luminescence array including first and second electrodes crossing each other with having an organic light-emitting layer therebetween;
forming a signal supplying pad for supplying a driving signal to the organic electro-luminescence array;
forming at least one layer of protective film provided on the organic electro-luminescence array to expose a portion of any at least one of the first and second electrodes; and
forming a signal line having at least portion thereof provided on the protective film and connected to the electrode and the signal supplying pad.

8. The method according to claim 7, wherein the signal line is formed from the same material as any one of the first and second electrodes.

9. The method according to claim 7, further comprising the step of:
forming a barrier rib provided in parallel to the signal line to electrically separate the signal line.

10. The method according to claim 7, wherein the first and second electrodes are formed by a photolithography and an etching process using a mask.
